(19) United States
(12) Patent Application Publication
(10) Pub. No.: US 2009/0076779 A1
(43) Pub. Date: Mar. 19, 2009

(54) HEATING, VENTILATING, AND AIR-CONDITIONING DESIGN APPARATUS AND METHOD

(76) Inventors: Joseph V. Simmons, Highland, UT (US); Benjamin L. Davis, Riverton, UT (US); Alan L. Nicoll, Lehi, UT (US)

Correspondence Address: PATE PIERCE & BAIRD, 175 SOUTH MAIN STREET, SUITE 1250, SALT LAKE CITY, UT, 84111, US

(21) Appl. No.: 12/274,664

(22) Filed: Nov. 20, 2008

Related U.S. Application Data
(63) Continuation-in-part of application No. 11/738,994, filed on Apr. 23, 2007.
Application No. 11/738,994 is a continuation of application No. 09/976,187, filed on Oct. 12, 2001, now Pat. No. 7,209,870.
(60) Provisional application No. 60/240,197, filed on Oct. 12, 2000.

(51) Int. Cl. G06F 17/50

(52) U.S. Cl. 703/1

(57) ABSTRACT

A method for designing an HVAC system. The method may comprising operating a computer program to create a virtual floor plan, detecting automatically, by the computer program, an enclosed space within the virtual floor plan, and calculating automatically, by the computer program after the detecting, a load corresponding to the enclosed space. The method may further include providing, by the computer program, a palette of HVAC components, instructing the computer program to assign at least one HVAC component from the palette to the enclosed space, and assigning automatically, by the computer program, a capacity to the at least one HVAC component, the capacity corresponding to the load calculated for the enclosed space.

### RELATED APPLICATIONS

This application is a continuation-in-part of U.S. patent application Ser. No. 11/738,994 filed Apr. 23, 2007, which is a continuation of U.S. patent application Ser. No. 09/976,187 filed Oct. 12, 2001, which claims the benefit of U.S. Provisional Patent Application Ser. No. 60/240,197 filed Oct. 12, 2000. U.S. patent application Ser. No. 11/738,994, U.S. patent application Ser. No. 09/976,187, and U.S. Provisional Patent Application Ser. No. 60/240,197 are incorporated herein by reference.

### BACKGROUND

1. The Field of the Invention

This invention relates to software and computer systems and, more particularly, to novel systems and methods for design modeling of fluid and energy handling systems.

2. The Background Art

The need to condition the environment in which people live has existed as long as sun, rain, and winter storms. The solutions have been many and varied, depending on the availability of shelter, fuels, cooling materials, insulation, fans, and so forth. In more recent history, refrigeration systems, heating systems, and their various combinations have taken advantage of new thermodynamic cycles and a wide variety of working fluids.

Nevertheless, much of the process of designing systems for heating, ventilating, and air conditioning (HVAC) is an iterative process of design and analysis. Moreover, a change in a parameter may affect the performance of many other parameters, or limit the applicability of other equipment, configurations, or analyses. Also, the methods used for design and analysis will often require considerable familiarity with both engineering principles and available manufactured equipment. Much of the design process is beyond the intuitive sense of an individual. Documentation is likewise esoteric and non-intuitive.

What is needed is a system for rapidly designing, analyzing, and redesigning HVAC systems. It would be an advancement in the art to rely on an object oriented programming system and intuitive, visual icons. It would be a further advance in the art to provide automatic calculation of interface information, thus keeping the specifications and performance parameters consistent among associated components.

There are many stages involved in the design and implementation of an HVAC system. The first stage is to design a building that an HVAC system will serve. A loads program is used to calculate airflow and heating requirements for the building, based on established codes. An HVAC system must then be designed, using available components. A control system must be designed to control the HVAC system. And finally, all the components of the system must be purchased and installed. This process requires that each step use the output of a previous step. Often, the data used by one step must be manually extracted from the output data of a preceding step. The extracted data may then need to be manually converted to a computer readable form.

What is needed is a system capable of integrating the many steps of the design process, allowing each step to automatically extract needed information from the preceding step. Such a system would allow for information to be entered into a computer once, rather than at each stage of the design process.

### BRIEF SUMMARY AND OBJECTS OF THE INVENTION

In view of the foregoing, it is a primary object of the present invention to provide an apparatus and method to design, analyze, and document HVAC systems.

It is an object to provide an intuitive, graphical system relying on object-oriented programming and intuitive icons.

It is an object of the present invention to allow a designer to easily create many different, yet consistently schematic representations of various aspects of the same design.

It is an object of the present invention to provide a method and apparatus to integrate steps of the design process into a single system, allowing each step to automatically use the output of a preceding step.

It is an object of the present invention to provide a method and apparatus to access the descriptions of actual HVAC system equipment and use them in the design and analysis processes.

It is an object of the present invention to provide a software application for interacting directly with software independently provided by an equipment vendor unrelated to the designer or the provider of HVAC system design software. This allows an HVAC system designer to more easily use the actual properties of available components in the design and analysis process.

It is an object of the present invention to provide a system for automatically determining design parameters, freeing a user from having to make numerous routine design decisions, and reducing the level of skill required to design an HVAC system.

It is an object of the present invention to provide a system to create a design for an HVAC system and use that design to create a plan or design of a corresponding control system for controlling an implementation of the HVAC design.

It is an object of the present invention to provide a system for automatically obtaining information concerning manufactured equipment suitable for use in an HVAC system. This may include new products, modifications made to the properties of existing products, the current cost of products, the availability of products, and the like.

It is an object of the present invention to provide a system enabling a user to contact businesses supplying or manufacturing HVAC system equipment components (design elements).

It is an object of the present invention to provide a system whereby a business may be credited financially for providing software to a user who subsequently uses the software to make a purchasing decision. This may involve a manufacturer paying a commission to the provider of the software whenever a user of the software decides to use the manufacturer's equipment in a design provided by the software.

Consistent with the foregoing objects, and in accordance with the invention as embodied and broadly described herein, a method and apparatus are disclosed in one embodiment of the present invention as including an application that is executable on a general purpose digital computer. The application presents graphical icons representing equipment, connectors, and all other components (collectively, design elements) that may be used to assemble a model of an HVAC system, including all specified components operably connected together.

### BRIEF DESCRIPTION OF THE DRAWINGS

The foregoing and other objects and features of the present invention will become more fully apparent from the following description, taken in conjunction with the accompanying drawings. Understanding that these drawings depict only typical embodiments of the invention and are, therefore, not to be considered limiting of its scope, the invention may be seen in additional specificity and detail in the accompanying drawings where:

FIG. 1 is an illustration of a general purpose computer suitable for use in accordance with the present invention;

FIG. 2 is a schematic block diagram of data structures suitable for implementing at least one embodiment of an apparatus and method in accordance with the invention;

FIG. 3 is a schematic block diagram of data structures suitable for implementing a data module;

FIG. 4 is a schematic block diagram of data structures suitable for implementing a user interface module in accordance with the invention;

FIG. 5 is an illustration of a user interface in accordance with the invention showing different schematic representations of a design element;

FIG. 6 is an illustration of a user interface in accordance with the invention showing features of the connections between design elements;

FIG. 7 is an illustration of a user interface in accordance with the invention showing the modification of the properties of a design element;

FIG. 8 is an illustration of a user interface in accordance with the invention showing novel features of the connections between design elements;

FIG. 9 is an illustration of a user interface in accordance with the invention showing novel features of the connections between design elements;

FIG. 10 is a schematic block diagram of data structures suitable for implementing a product module in accordance with the invention;

FIG. 11 is a schematic block diagram of data structures suitable for implementing a design module in accordance with the invention;

FIG. 12 is a schematic block diagram of data structures suitable for implementing an analysis module in accordance with the invention;

FIG. 13 is a schematic block diagram of data structures suitable for implementing an input module in accordance with the invention;

FIG. 14 is a schematic block diagram of data structures suitable for implementing an output module in accordance with the invention;

FIG. 15 is a schematic block diagram illustrating at least one embodiment of a hierarchical object oriented architecture suitable for use in the invention;

FIG. 16 is a schematic block diagram of data structures suitable for implementing a project object in accordance with the invention;

FIG. 17 is a schematic block diagram of data structures suitable for implementing a shape object in accordance with the invention;

FIG. 18 is a schematic block diagram of data structures suitable for implementing a component object in accordance with the invention;

FIG. 19 is a schematic block diagram of data structures suitable for implementing a connector object in accordance with the invention;

FIG. 21 is a schematic block diagram of data structures suitable for implementing an information updating object in accordance with the invention;

FIG. 22 is a schematic block diagram of data structures suitable for implementing at least one embodiment of an apparatus and method in accordance with the invention;

FIG. 23 is a schematic block diagram illustrating a method for designing an HVAC system in accordance with the present invention;

FIG. 24 is a schematic of a screen shot of a user interface in accordance with the invention showing a virtual floor plan in accordance with the present invention;

FIG. 25 is a schematic of a screen displaying the virtual floor plan of FIG. 24 with HVAC components added in accordance with the present invention;

FIG. 26 is a schematic of a screen display of a virtual floor plan of another floor of the structure illustrated in FIG. 24 with HVAC components added in accordance with the present invention; and

FIG. 27 is a schematic block diagram illustrating how various systems may be designed and integrated in accordance with the present invention.

### DETAILED DESCRIPTION OF THE PREFERRED EMBODIMENTS

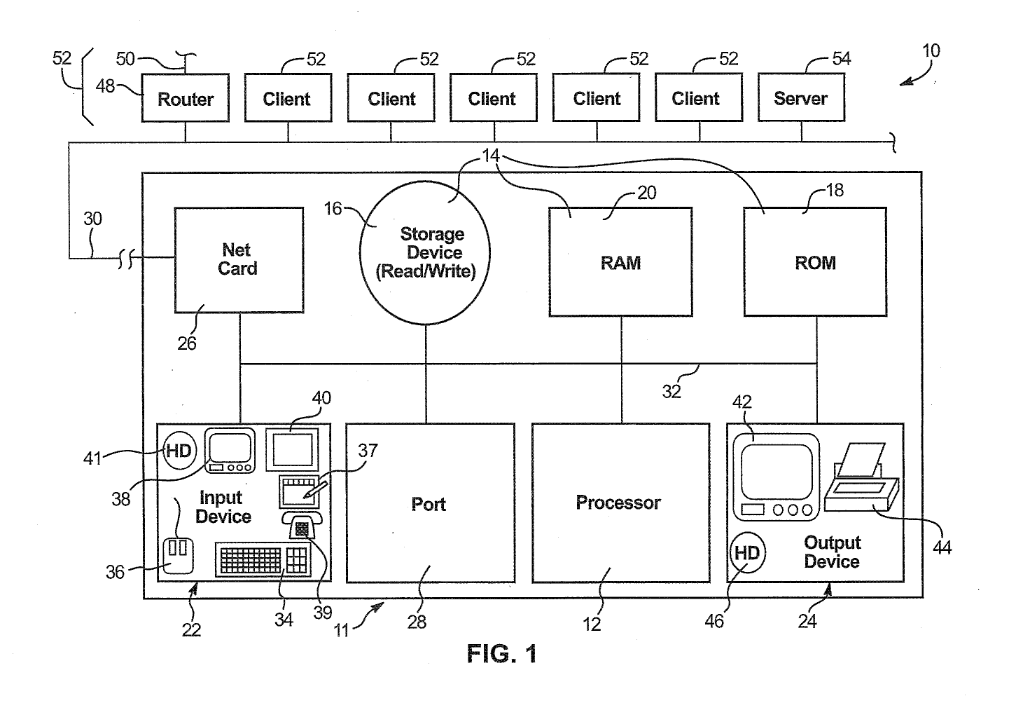

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 21, is not intended to limit the scope of the invention, as claimed, but it is merely representative of certain presently preferred embodiments in accordance with the invention. These embodiments will be best understood by reference to the drawings, wherein like parts are designated by like numerals throughout.

Those of ordinary skill in the art will, of course, appreciate that various modifications to the details illustrated FIGS. 1-21 may easily be made without departing from the essential characteristics of the invention. Thus, the following description is intended only by way of example, and simply illustrates certain presently preferred embodiments consistent with the invention as claimed herein.

Referring now to FIG. 1, an apparatus 10 may include a node 11 (client 11, computer 11) containing a processor 12 or CPU 12. The CPU 12 may be operably connected to a memory device 14. A memory device 14 may include one or more devices such as a hard drive 16 or non-volatile storage device 16, a read-only memory 18 (ROM) and a random-access (and usually volatile) memory 20 (RAM).

The apparatus 10 may include an input device 22 for receiving inputs from a user or another device. Similarly, an output device 24 may be provided within the node 11, or accessible within the apparatus 10. A network card 26 (interface card) or port 28 may be provided for connecting to outside devices, such as the network 30.

Internally, a bus 32 (system bus 32) may operably interconnect the processor 12, memory devices 14, input devices 22, output devices 24, network card 26 and port 28. The bus 32 may be thought of as a data carrier. As such, the bus 32 may be embodied in numerous configurations. Wire, fiber optic line, wireless electromagnetic communications by visible light, infrared, and radio frequencies may likewise be implemented as appropriate for the bus 32 and the network 30.

Input devices 22 may include one or more physical embodiments. For example, a keyboard 34 may be used for interaction with the user, as may a mouse 36. A touch screen 38, a telephone 39, or simply a telephone line 39, may be used for communication with other devices, with a user, or the like.

Similarly, a scanner 40 may be used to receive graphical inputs which may or may not be translated to other character formats. A hard drive 41 or other memory device 14 may be used as an input device whether resident within the node 11 or some other node 52 (e.g., 52a, 52b, etc.) on the network 30, or from another network 50.

Output devices 24 may likewise include one or more physical hardware units. For example, in general, the port 28 may be used to accept inputs and send outputs from the node 11. Nevertheless, a monitor 42 may provide outputs to a user for feedback during a process, or for assisting two-way communication between the processor 12 and a user. A printer 44 or a hard drive 46 may be used for outputting information as output devices 24.

In general, a network 30 to which a node 11 connects may, in turn, be connected through a router 48 to another network 50. In general, two nodes 11, 52 may be on a network 30, adjoining networks 30, 50, or may be separated by multiple routers 48 and multiple networks 50 as individual nodes 11, 52 on an internetwork. The individual nodes 52 may have various communication capabilities.

In certain embodiments, a minimum of logical capability may be available in any node 52. Note that any of the individual nodes 52, regardless of trailing reference letters, may be referred to, as may all together, as a node 52 or nodes 52.

A network 30 may include one or more servers 54. Servers may be used to manage, store, communicate, transfer, access, update, and the like, any number of files for a network 30. Typically, a server 54 may be accessed by all nodes 11, 52 on a network 30. Nevertheless, other special functions, including communications, applications, and the like may be implemented by an individual server 54 or multiple servers 54.

In general, a node 11 may need to communicate over a network 30 with a server 54, a router 48, or nodes 52. Similarly, a node 11 may need to communicate over another network (50) in an internetwork connection (e.g., Internet) with some remote node 52. Likewise, individual components of the apparatus 10 may need to communicate data with one another. A communication link may exist, in general, between any pair of devices or components.

By the expression “nodes” 52 is meant any one or all of the nodes 48, 52, 54, 56, 58, 60, 62, 11. Thus, any one of the nodes 52 may include any or all of the component parts illustrated in the node 11.

To support distributed processing, or access, a directory services node 60 may provide directory services as known in the art. Accordingly, a directory services node 60 may host software and data structures required for providing directory services to the nodes 52 in the network 30 and may do so for other nodes 52 in other networks 50.

The directory services node 60 may typically be a server 54 in a network. However, it may be installed in any node 52. To support directory services, a directory services node 52 may typically include a network card 26 for connecting to the network 30, a processor 12 for processing software commands in the directory services executables, a memory device 20 for operational memory as well as a non-volatile storage device 16 such as a hard drive 16. Typically, an input device 22 and an output device 24 are provided for user interaction with the directory services node 60.

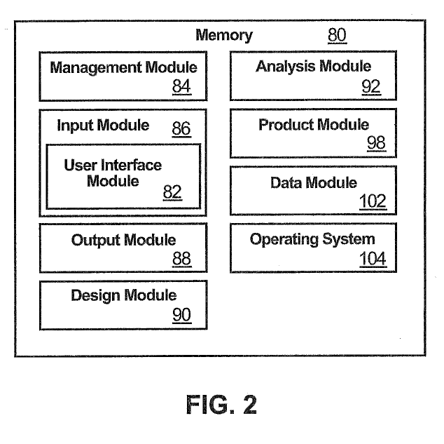

Referring to FIG. 2, a memory device 14 or memory devices 14 may store executable and operational data (e.g., data structures) in accordance with the invention. The memory device 14 or memory devices 14 may store a management module 84, an input module 86, an output module 88, a design module 90, an analysis module 92, a product module 98 and a data module 102. The memory device 14 or memory devices 14 may also store an operating system 104. An input module may include a user interface module 82, or the user interface module 82 may be a separate module.

Every module in accordance with the invention, may be anything from a single machine-level instruction, to an entire multimedia application. That is, an individual module 82, 84, 86, 88, 90, 92, 94, 96, 98 and 102, including all submodules thereof, can physically be stored in any size, shape, configuration, on any number of computers, in order to execute its function. Thus the management module 84 is typically that code that is logically executed to control the execution of the other modules 82, 84, 86, 88, 90, 92, 94, 96, 98, 102 and effect the communication of data therebetween.

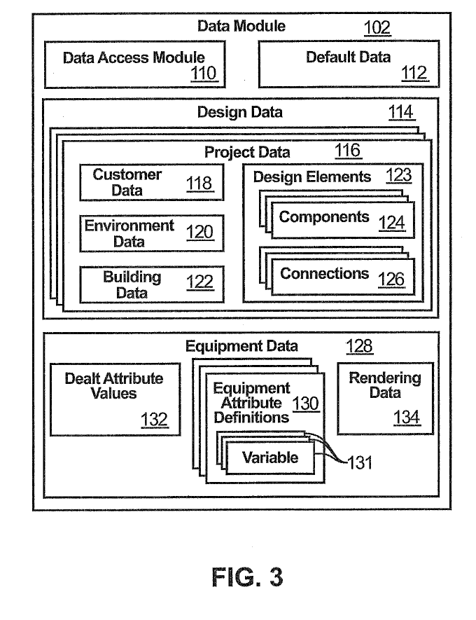

Referring to FIG. 3, a data module 102 may store data suitable for describing designs or elements of a design. A data module 102 typically includes a data access module for allowing other modules 82, 84, 86, 88, 90, 92, 94, 96 and 98 to access the data contained therein.

The default data 112 is typically data that can be used for parameters used to describe the design of an HVAC system. For example, default data 112 may include acceptable values for the outlet temperature of a boiler. One utility of default data 112 is that a user is not required to research or calculate values which are already known in the HVAC arts, but rather, can rely on these data being readily available. Default data 112 may be static stored values or may be calculated based on the design data 114.

A data module 102 may include design data 114. Design data 114 typically contains data describing a design or designs created by a user. Typically the design data 114 consists of one or more sets of project data 116 or projects 116. The project data 116 may include customer data 118, environment data 120, building data 122, components 124 and connections 126. For example, customer data 118 may comprise the name of the customer for which a project was made, contact information, or the like. Environment data 120 may include information describing the physical location where the actual HVAC system being designed will be built. This information may include the outside temperature of the air during the heating season and the cooling season, the elevation, and the relative humidity.

Environment data 120 may also include the wet bulb and dry bulb temperatures during both the cooling season and the heating season, and the enthalpy of the air during the cooling season and the heating season. Building data 122 may include the rate of heat loss, the number of people normally in the building, the air flow requirements, the size of internal spaces, and the like.

The design elements 123 are records describing the properties of the equipment to be placed in an actual implementation of an HVAC system. Design elements 123 may be records such as component records 124 or components 124 and connection records 126 or connections 126. The design elements 123 of the project data 116 are all of the data describing equipment placed in the design by the user as well as descriptions of the spaces to be serviced by the HVAC system being designed.

The equipment that may be placed in a project may include all equipment that can be used in any actual HVAC system. The components 124 typically include descriptions of equipment that affect the fluids flowing through an HVAC system.

The connections 126 typically include descriptions of pipes and ducts connecting equipment in an HVAC system design. The connections 126 may describe which piece of equipment is connected to which other piece of equipment as well as a description of the connecting fasteners, coupling pipe, duct, or the like. A connection 126 may also include data describing any head loss in a connecting pipe or duct such as frictional losses, fitting losses, elevation changes or the like. A connection 126 may describe the appearance of the connecting piper or duct in a schematic such as its location on a computer screen and its shape.

The equipment data 128 may provide data describing components 124 and connections 126 that a user can place in a design. The equipment data 128 may include equipment attribute definitions 130. The equipment attribute definitions 130 may include a definition of properties 131 that can be used to describe a physical embodiment of a design element. Properties 131 may comprise data structures storing any suitable data, such as text, numerical data, and the like.

Equipment attribute definitions 130 may also include definitions of equipment suitable for use in HVAC systems such as pumps, air separators, expansion tanks, air cooled chillers, water cooled chillers, cooling towers, cooling tower sumps, boilers, heat exchangers, air handlers, plenums, fans, louvers, roof hoods, dampers, coils, filters, radiant objects, fan coils, terminal boxes, unit heaters, pipe tees, duct tees, pipes, ducts, and the like.

Components 124 and connections 126 may comprise values corresponding to the properties 131 defined in the equipment attribute definitions. For example a component 124 that represents a pump will contain values for the properties 131 defined in the equipment attribute definition 130 for a pump.

Rendering data 134 may include graphical data associated with a particular equipment attribute definition. For example boilers will have a schematic representation that will be used by the user interface module 82 to draw them on a computer screen. An output module 88 may likewise render a graphical description of a design to an output device 24.

Many different graphical representations may correspond to an equipment attribute definition 130. For example, each type of fan may have its own corresponding graphical representation. An equipment attribute definition 130 may also have various graphical representations mapped to different values of its properties 131. For example, design elements 123 may have a property indicating the manufacturer or model of a piece of equipment.

The rendering data 134 may, accordingly, contain graphical descriptions corresponding to the manufacturer or model of that design element. Rendering data 134 may also include different graphical representations of an equipment attribute definition 130 corresponding to the property 131 or properties 131 describing the type of fluid passing through it.

For example, the graphical representation of a fan that forces air through an air handler may be a different color than a fan that draws air from a space and exhausts it to the outside. Likewise, the equipment attribute definition 130 of a connection 126 may have a variety of graphical representations corresponding to a component 126 or components 126 connected to or characteristics of the fluid it carries.

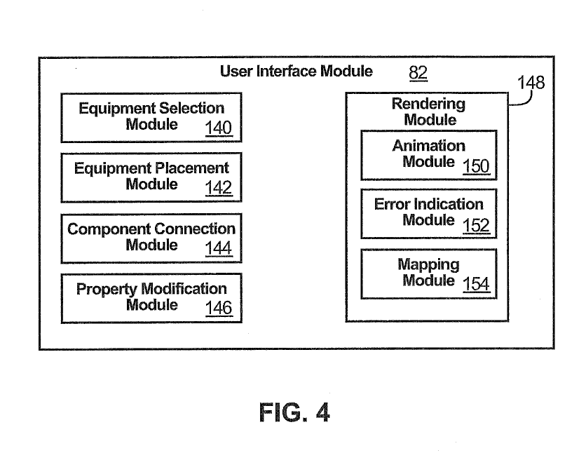

Referring to FIG. 4, a user interface module 82 is typically responsible for handling user interface events such as mouse clicks, keystrokes, or the like and rendering user interface elements on a computer screen. A user interface module 82 may include an equipment selection module 140, equipment placement module 142, a component connection module 144, a property modification module 146, and a rendering module 148.

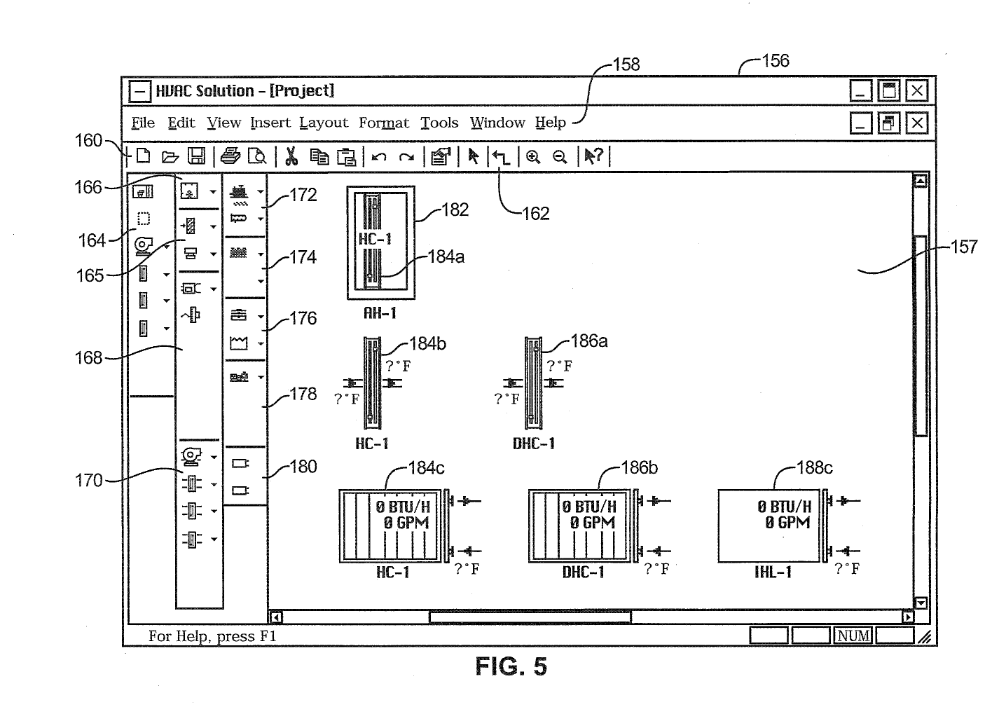

Referring to FIG. 5, while continuing to refer to FIG. 4, a user interface module 82 may present a user with a window 156. A window 156 may include a menu bar 158, a tool bar 160, and a variety of palettes 164, 165, 166, 168, 170, 172, 174, 176, 178, 180. For example, a window 156 may include a drawing tool bar supporting a user in drawing and detailing any picture or detail to be incorporated within the window 156. A window 156 may include a region 157 for displaying a graphical representation of a project 116.

An equipment selection module 140 may allow a user to select a type of component and place a design element in a project 116. In a typical embodiment the equipment selection module 140 may present a user with palettes 164, 165, 166, 168, 170, 172, 174, 176, 178, 180 containing icons representing design element types to choose from. A user may click in a palette 164, 165, 166, 168, 170, 172, 174, 176, 178, 180 in order to choose a type of design element to place in a schematic or to select for inclusion in a design. An equipment placement module 142 may then allow a user to click in a region 157, thereby placing a design element 123 in a project 116.

The equipment selection module 140 may arrange the palettes 164, 165, 166, 168, 170, 172, 174, 176, 178, 180 in groups on a computer screen. For example, a palette 164 may present schematic representations of components suitable for placement in an air handler schematic. Palettes 166, 165, 168 and 170 may be grouped together and present components suitable for placement in an air flow schematic. Palettes 172, 174, 176, 178 and 180 may be grouped together and include schematic representations of components suitable for placement in a hydronic schematic.

A user may also be presented with a connection tool 162, which may be embodied as an icon 162. A user may click on the icon 162 and then click on various design elements in order to connect them.

In one embodiment of the present invention, a user may be presented with a palette 166, which a user may click and then click in region 157 in order to place a component 124 corresponding to a space in a project 116. The space may represent a room or any other interior region of a structure to be served by an HVAC system.

In one embodiment of an apparatus and method in accordance with the present invention, a user may select a component type and place a component 124 of that type in a project 116. A user may then click in a region 157 and place a different schematic representation of that same component 124 without having to click again on that element or selection on the palette 164, 165, 166, 168, 170, 172, 174, 176, 178, 180.

For example, a user may click on a palette 164 and select an entry or element such as a heating coil. A user may then click on a schematic representation 182 of an air handler and place the air handler's schematic representation of a heating coil 184a in the air handler 182. A user may then click in the region 157 and place an air flow schematic representation of the heating coil 184b in an air flow schematic. The user may then click again in the region 157 and place a hydronic schematic representation of a heating coil 184c in a hydronic schematic.

In one embodiment, various schematic representations may represent different operational contexts. The operational contexts may represent the transport of mass, energy, or the like. For example a hydronic schematic may present design elements in the operational context of the effect they have on the volume of working fluid flowing through a system as well as the energy they extract or add to the working fluid. By contrast, an air flow schematic may represent a operational context wherein design elements 123 are analyzed according to their effect on the properties of the air flowing through an HVAC system.

A user may not need to be limited to placing every possible schematic representation of a component 124 in a project 116. For example, a user may select a heating coil from a palette 170 and place an air flow schematic representation of a heating coil 186a in the region 157, a user may then automatically place a hydronic representation 186b of the heating coil in a hydronic schematic. As another example a user may choose to merely place a heat load 188 (a hydronic equivalent to a heating coil) in a hydronic schematic without placing any other corresponding schematic representations thereof in the design.

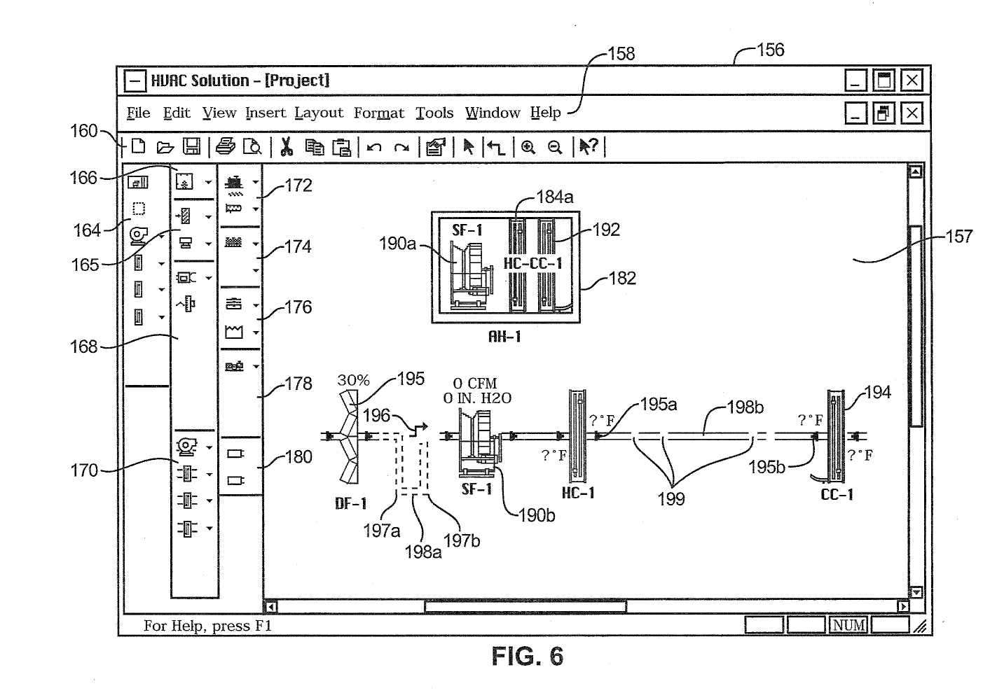

Referring to FIG. 6, while continuing to refer to FIG. 4, a component connection module 144 may connect components 124. For example a user may click on a damper 195, click at various places 197a, 197b in region 157, and then click on a fan 190b. A user may click in region 157 in order to create corners 197a, 197b in a connector 198a. When a user connects any two components in one schematic representation of a project 116, the two pieces of equipment will be automatically connected in other schematic representations of the project 116. For example, if a user were to connect fan 190b to heating coil 184b, then, a connection 126 would automatically connect fan 190a to heating coil 184a in the air handler 182.

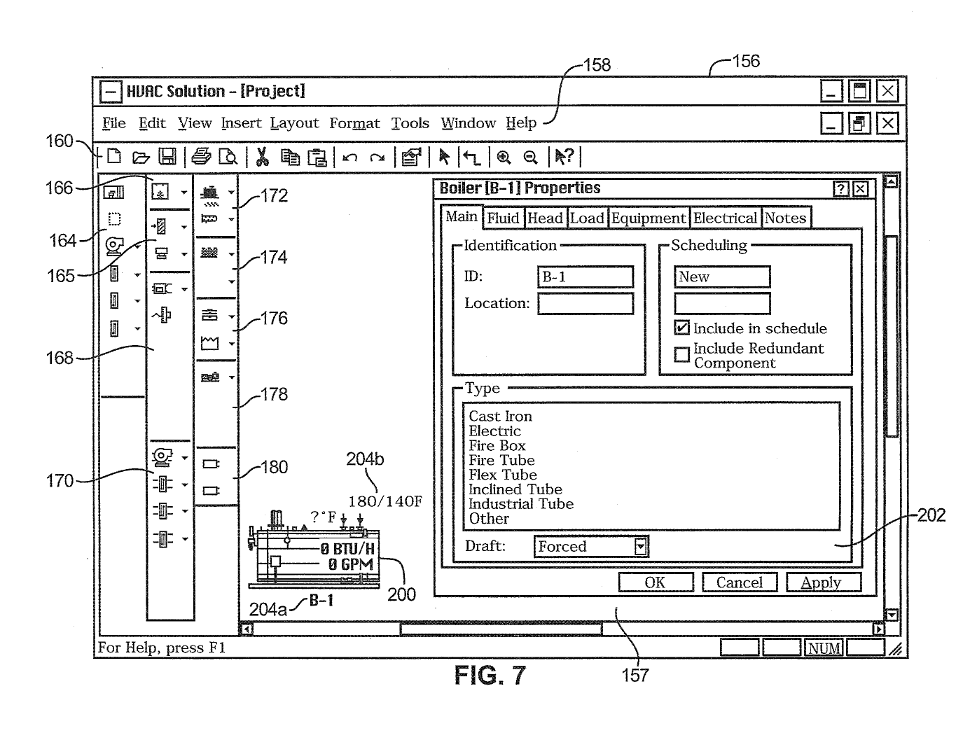

Referring to FIG. 7, while continuing to refer to FIG. 4, a property modification module may allow a user to modify the properties 131 of a design element. For example a user may click on a graphical representation 200 of a design element 123, such as a boiler 200 and be presented with a dialog box 202 or other interface 202 for inputting information. A user may then view and modify the values of the properties 131 describing a design element 123.

When a user modifies the values of the properties 131 of one schematic representation of a component 124 or connection 126 the values of the properties 131 describing other representations of the component 124 or connection 126 will automatically be modified as well. For example if the heating coil 184c (FIG. 5) were to be modified in some way, then the heating coils 184a, 184b will automatically be modified as well.

Referring again to FIG. 4, a rendering module 148 may render graphical representations of design elements 123 to an output device 24. The rendering module 148 may also render two dimensional and three dimensional drawings of an HVAC system or a portion thereof. A rendering module 148 may include an animation module 150, an error module 152 and a mapping module 154. An animation module 150 may provide a mechanism to visually simulate the flow of fluid through an HVAC system. For example a user is able to see a simulation of fluid flowing through the various components of the system. One utility of this is to allow a user to visually verify that the system now designed will function as it was designed to function.

An error module 152 may provide a means to visually indicate errors in an HVAC system design. For example, in FIG. 6, the heating coil 184b is connected to a cooling coil 194. However the arrow 195a is pointed in a direction opposite to the direction of the arrow 195b. This indicates that the outlet of the heating coil 184a, 184b is connected to the outlet of the cooling coil 194. Because this is an unacceptable design, the connector 198b is shown with breaks 199 in line density to visually indicate the error.

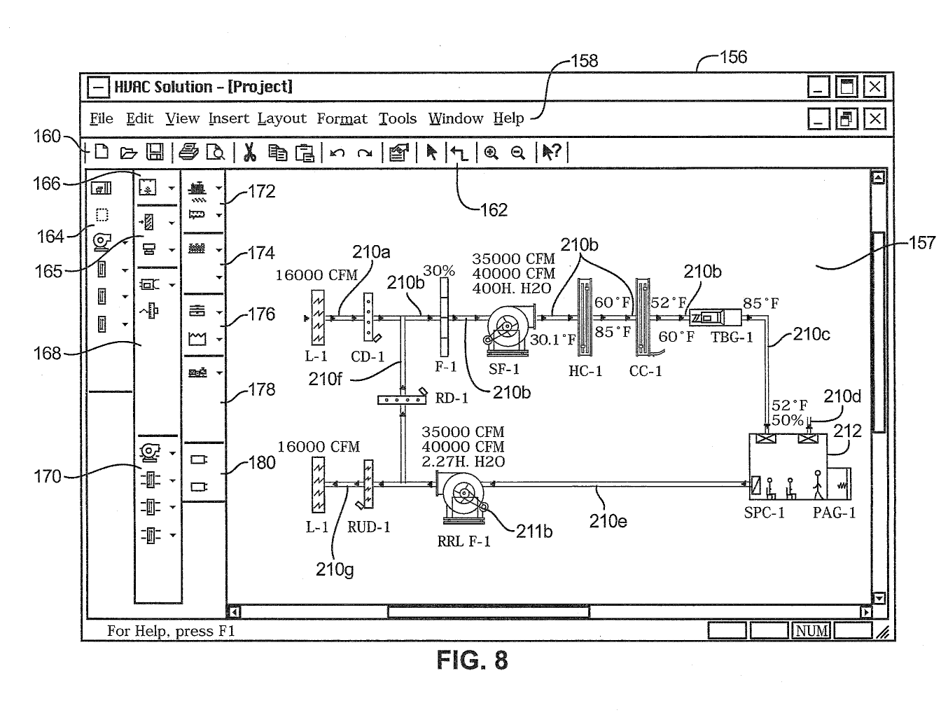

Referring to FIG. 8, while continuing to refer to FIG. 4, a mapping module 154 may provide for drawing the graphical representation of a piece of equipment mapped to the values of the properties 131 describing it. For example, the color that a connector is drawn with may be mapped to characteristics of the fluid that is passing through it. For example, a connector 210 a may be colored one color because it carries air from outside of the system. The connectors 210b and 210c may be colored a different color because they carry air entering the conditioned space 212. Connectors 210d and 210g may have a distinct color corresponding to air vented to the outside environment. A connector 210e may have a distinct color corresponding to air that is being returned to the air handler and relieved to the outside. A connector 210f may have a distinct color indicating that it carries air that is to be recirculated through an air handler.

Any piece of equipment may be mapped to multiple graphical representations depending on the values of its properties 131. For example, a fan 211a inside an air handler may be rendered differently than an otherwise identical fan 211b handling air being returned to an air handler or relieved to the outside of a system.

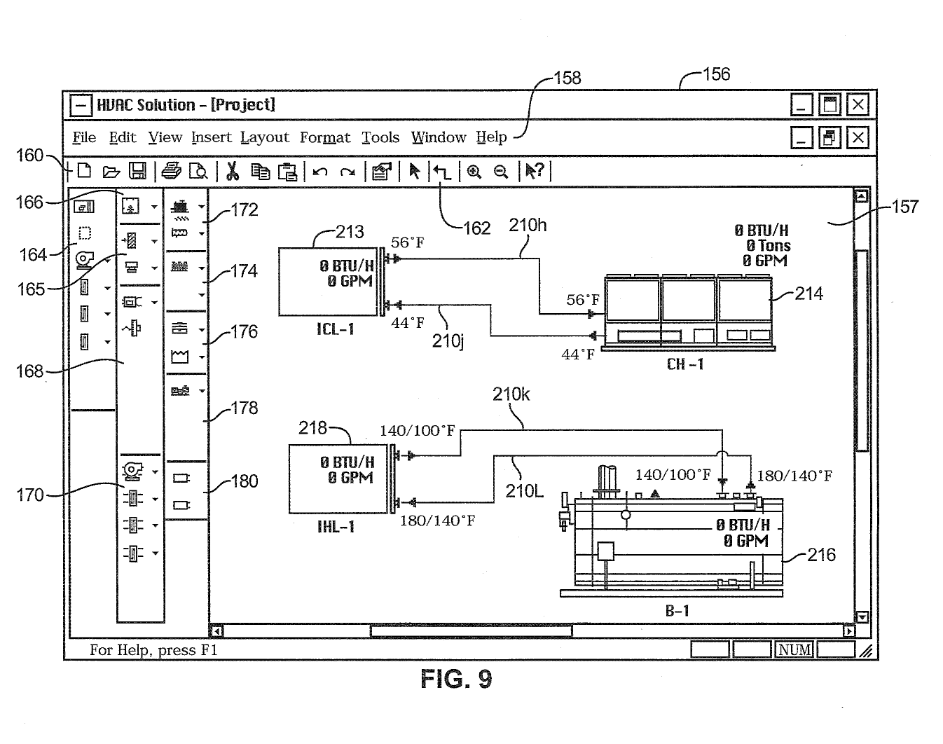

FIG. 9 illustrates another example of how the graphical representation of a piece of equipment may depend on the values of its variables. For example, a connector 210h connecting the outlet of a cooling load 213 to the inlet of a chiller 214 may be rendered in a color indicating that it is at a higher temperature than the fluid flowing through the connector 210j, which carries fluid from the outlet of the chiller 214 to the inlet of the cooling load 213. The color of connectors 210h and 210j may both be different from the colors used for connectors 210k and 210l used to connect a boiler 216 to a heating load 218 (e.g., heating or cooling), providing a visual indication that connectors 210h and 210j are being used to connect cooling components and that connectors 210k and 2101 are used to connect components of a heating system.

The mapping module 154 may also render a graphical description of a design element 123 mapped to the design elements 123 to which it is connected. For example connectors 126 carrying different fluid having different characteristics may both be connected to a tee having a third connector 126 leaving the tee. The connector 126 carrying fluid away from the tee may be rendered in a different color indicating it carries a mixture of the fluid entering the tee.

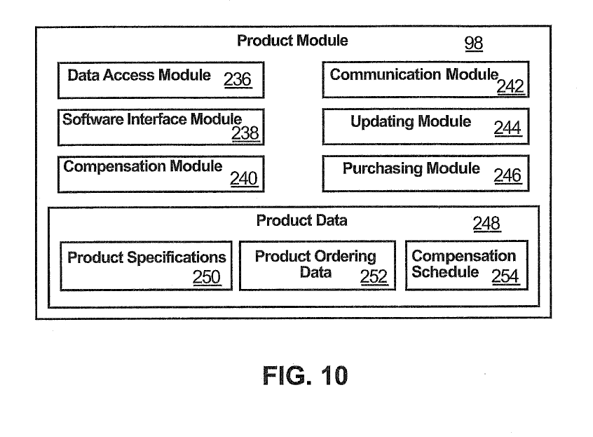

Referring to FIG. 10, a product module 98 may provide a mechanism for a user to access data describing actual manufactured equipment that may be purchased in order to build an actual HVAC system design. This data may include sets of values which the properties 131 of a design element may assume. Through this process, a design may be analyzed based on representations of equipment that reflect more closely what the actual physical embodiment of a design will be like. A product module 98 may include a data access module 236, a software interface module 238, a compensation module 240, a communication module 242, an updating module 244, a purchasing module 246, and product data 248.

The data access module 236 may allow a user to access the product data 248. The data access module 236 may allow a user to choose from a list of products described in the product data 248. Upon choosing a product, the set of properties 131 of a component 124 or connection 126 may assume values corresponding to those characterizing to the product. For example, a component 124 representing a pump may assume values for its properties 131 corresponding to measured values of an actual manufactured pump. A data access module 236 may also enable other modules 82, 84, 86, 88, 90, 92, 94, 96, 98, 102 to access the data stored in the product module 98.

A software interface module 238 may interface with software provided by vendors of manufactured products. Vendors of equipment suitable for use in HVAC systems may provide software that will allow a user to more easily select a manufactured product based on the requirements of the HVAC system being designed and built by the user. A software interface module 238 may allow a user to transfer data between an apparatus 10 and software provided by a vendor.

One utility of this is that a user is not required to manually enter data into the vendor software and then manually enter any output data into an apparatus 10. For example, a manufacturer of pumps may provide a software package into a which a user may enter a flow rate needed and the rise in pressure that a pump needs to provide. The software may then output the specifications of an actual pump that most closely matches the needs originally input into the software.

A software interface module 238 may enable a user to specify which vendor software package to use and then automatically calculate the values of the properties 131 for a design element corresponding to actual manufactured equipment and optimally satisfying the requirements of the design. A software interface module 238 may then automatically set the values of the properties 131 of a design element to those corresponding to the actual equipment.

A compensation module 240 may enable a provider of an apparatus 10 or any of the modules 82, 84, 86, 88, 90, 92, 94, 96, 98, 102 thereof to be compensated for providing a mechanism for a user to access data concerning actual manufactured products. The compensation module 240 may notify a manufacturer or supplier of a piece of equipment when a user selects a piece of equipment sold by the manufacturer for incorporation into a design.

For example, if a user specifies that a design element 123 in a project 116 may assume values for its properties 131 corresponding to a physical design element manufactured by a manufacturer X, then the manufacturer X may be so notified, via a network 30 or other communication means. A provider of the apparatus 10 (e.g., system 10, application 10) or any of the modules 82, 84, 86, 88, 90, 92, 94, 96, 98, 102 thereof may receive a sales commission for aiding in the advertisement and sale of the design element.

A compensation module may contact a manufacturer or supplier of a product automatically via a communication module 242 to place an inquiry, request for quote, or order. A provider of the system 10 or any of the modules 82, 84, 86, 88, 90, 92, 94, 96, 98, 102 may also be automatically informed concerning selections that take place.

A compensation module 240 may make use of a compensation schedule 254. The compensation schedule 254 may provide data concerning how much compensation a provider of an apparatus 10 or any of the modules 82, 84, 86, 88, 90, 92, 94, 96, 98, 102 thereof shall be entitled too in the event that a user chooses to incorporate a particular product into a design.

A communication module 242 may facilitate communication between an apparatus 10 (e.g., application 10 on a computer 11) and other nodes 52 by means of a network 30. A communication module 242 may function in conjunction with an updating module 244 and product specifications 250. A communication module 242 may permit an updating module 10 to communicate across a network 30 with manufacturers of equipment in order to obtain current information concerning available products. This may include obtaining information concerning the specifications of new products, changes to the specifications of products, and the like.

The updating module 244 may then store the information obtained in the product specifications 250. The updating module 244 may obtain the information concerning products from any input device 22. For example an updating module 244 may read data from a compact disk (CD) or any other computer readable medium provided by a manufacturer. The product specifications 250 may be embodied as records describing values for the properties 131 of products that are available for use in actual implementations of HVAC systems.

An updating module 244 may likewise obtain current data for storage in a compensation schedule 254 or product ordering data 250. A communication module 242 may also enable a user to contact a manufacturer or supplier of a product, without requiring that the user supply contact information, such as an electronic mail address or the like.

A purchasing module 246 may function in conjunction with a communication module 242 and product ordering data 252 to enable a user to automatically order equipment from a supplier of equipment. The purchasing module 246 may gather data concerning a project 116 and compile a lists of equipment that will need to be purchased in order to implement a project 116. The data gathered may summarize the properties of the design elements 123, such as the number and manufacturer of each type of design element.

For example, the purchasing module may compile a list containing the number of pumps that will need to be bought from a particular vendor, as well as the number of other design elements to be bought. Product ordering data may provide information facilitating the ordering of equipment such as information needed to contact a vendor over a network 30. A communication module 242 may permit a purchasing module 246 to automatically contact suppliers of equipment over a network 30 in order to arrange for the purchase of equipment for use in a physical implementation of a project 116.

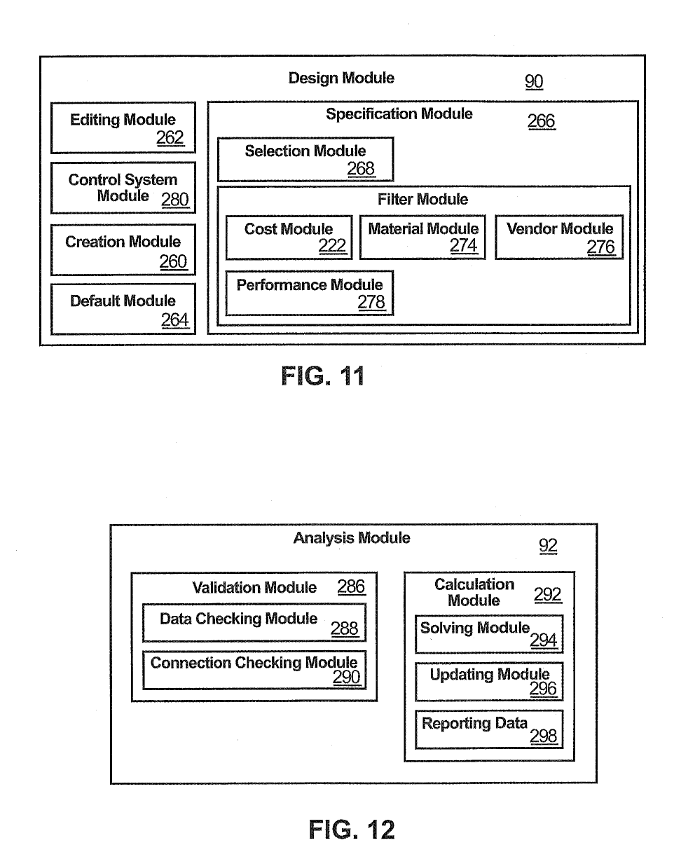

Referring to FIG. 11, a design module 90 may include a creation module 260, an editing module 262, a default module 264, and a specification module 266. A creation module may function in conjunction with the equipment placement module 142 of the user interface module 82 such that when a user places a piece of equipment in a region 157, a corresponding component 124 is stored with project data 116. Likewise, the creation module may create a connection record when a user connects components 124 using the component connection module 144 of the user interface module 82.

In certain embodiments of the invention supporting the placement of multiple schematic representations of the same design element 123, a creation module 260 may store distinct design elements 123 corresponding to each schematic representation of the design element. The creation module 260 may also store design elements 123 containing only sufficient data to link one design element 123 to another design element 123 actually corresponding to another schematic representation of the same hardware design element 123.

For example, a heating coil placed in an air handler schematic may have a component record 124 stored in a project 116. The airflow schematic representation of the same heating coil may be stored as a component record 124 that merely contains data identifying the component record 124 storing the air handler schematic representation. Alternatively a creation module 260 may store a single design element 123 containing all the properties 131 of all schematic representations of such a design element 123.

The editing module 262 may work in conjunction with a property modification module 146 such that a user may edit the values of the properties 131 of a design element 123. The editing module 262 may automatically make corresponding changes to design elements 123 corresponding to other schematic representations of the design element 123 edited.

A default module 264 may automatically provide values for design data 114, so a user is spared the time and bother of filling in values for which acceptable values may be catalogued, calculated otherwise easily known and do not vary greatly from one project 116 to another project 116. For example, it is common for boilers to have the same outlet fluid temperature. The default module may use the data access module 110 of the data module 102 in order to access default attribute values 132 in order to obtain default values for the properties 131 of a design element 123.

The default module 264 may, in some embodiments, supply default values for the properties 131 of a design element 123 based solely on values stored within the default attribute values 132. Alternatively, or in addition, the default module 264 may also automatically calculate certain default values based on other design data 114, such as the environment data 120 of a project or the values of the properties 131 of other components 124 and connections 126 in a project 116.

A default module 264 may also provide a mechanism (e.g., code, tables, calculations, etc.) to specify default values for all equipment or for equipment of a specific type. For example, a user may specify that all pumps have a particular or standardized efficiency, thereby sparing a user the bother of manually changing this property 131 to synchronize the performance or requirements for every pump in a project 116.

A specification module 266 may enable a user to incorporate the known values for properties 131 of actual manufactured products into a project 116. The specification module 266 may enable a user to set the values of the properties 131 of a component 124 or connection 126 to those corresponding to an actual manufactured product. A selection module 268 may enable a user to select from a list of possible products.

For example, a user may be presented with a list of products. A user may click on an item in the list in order to indicate that a design element 123 shall assume values of properties 131 corresponding to an actual product.

The selection module may function in conjunction with a filter module 270 to enable a user to more easily select an ideal product for use in a project 116. A filter module 270 may include a cost module enabling a user to be selectively presented a list of available products sorted by cost. The cost module may also enable selective presentation of only those products that fall within a certain range of prices.

A material module 274 may enable a user to be selectively presented only those products made of a specific material. For example, by sorting and filtering, a user may specify a request to be presented only with those products made of brass or copper.

A vendor module 276 may selectively present to a user only those products supplied by a particular vendor. A performance module 278 may provide to a user a selectively presented set of products that satisfy certain performance requirements or fall within a range of performance requirements. A performance module 278 may also allow a user to specify that the selection module present lists of products sorted based on one or more performance criteria. The criteria used to choose products may include, for example, energy usage, power requirements, efficiency, length of service life, and the like.

Referring to FIG. 12, an analysis module 92 may include various executables, such as, for example, a validation module 286 and a calculation module 292. The validation module 286 may analyze the design data to determine unacceptable configurations or parameters. The connection checking module 290 may analyze the connections between components and provide feedback to the user indicating unacceptable connections. Unacceptable connections may include, for example, connecting the outlet of one component 124 to the outlet of another component 124. The connection checking module may function in conjunction with the error indication module 152 (FIG. 4) to visually indicate errors on a computer screen or other output device 24. For example, in FIG. 6, the breaks 199 in a connector 198b indicate that the outlet of a heating coil 184b is connected to the outlet of heating coil 194.

A data checking module 288 may indicate that the values of certain design parameters are unacceptable. Design parameters that may assume unacceptable values may include project data such as the properties 131 of components 124 or connections 126. Environment data 120, customer data 118, building data 122 and any other design data 114 may be checked by the data checking module 288 in order to verify that all data is consistent and reasonable. Unacceptable parameters may be those that are inconsistent with one another or that are physically improbable or impossible.

The calculation module 292 may analyze the components 124 and connections 126 along with other design data 114 in order to calculate certain design parameters. The solving module 294 may solve for parameters based on other parameters of the system. For example, the solving module 294 may calculate the energy input of a boiler based on the heat extracted from the working fluid by other components 124 and lost by connectors 126. The solving module 294 may solve, for example, for the air flow that an air handler must provide to a design based on the air flow requirements of all of the spaces in the design.

The updating module 296 may update the variables of components 124 or connections 126 that are affected when a user inserts new components 124 or connections 126 into a design. The updating module 296 may also update any design data 114 which may be affected by modifications to the design data 114. For example the updating module may update the air flow through an air handler when a space component record 124 is added to a project 116a,b. The updating module may also change the property 131 corresponding to the heat output of a boiler when the property 131 of a heating load, corresponding to heat extracted from the working fluid, is changed.

The reporting module 298 may analyze the design data 114 in order to generate reports summarizing important aspects of a system. For example the reporting module may generate a list of all power consuming equipment in a project 116 and calculate the overall power consumption of a project 116. The reporting module may also generate lists summarizing all of the equipment that a project 116 contains.

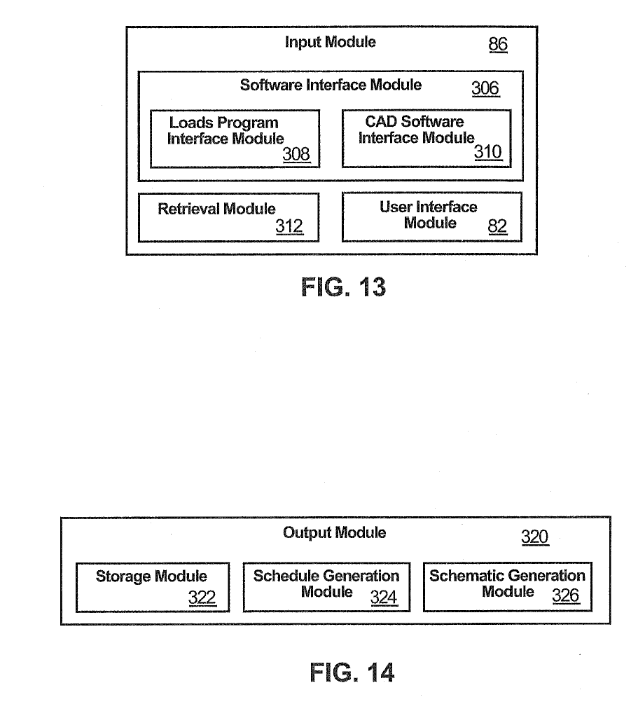

Referring to FIG. 13, an input module 86 may allow an apparatus 10 to input data from input devices 22. In one embodiment an input module 86 may include a user interface module 82. In such an embodiment all input from input devices 22 may be performed by an input module 86.

A software interface module 306 may allow a user to use information from other software packages within in a project 116. A loads program interface module 308 may work in conjunction with, or provide the functionality of, a loads program. A loads program is typically a software package that allows a user to enter information concerning the building an HVAC system will service. Based on this information the loads program typically calculates the air flow and heating requirements for the spaces in the building. A loads program interface module 308 may read the output of the loads program and automatically create a design element.

For example, a loads program may calculate that a building is going to require a certain flow rate of air as well as require a specific amount of heat input or heat output. The loads program interface module 308 may automatically create the components 124 and connections 126 necessary to describe an air handler satisfying the air flow requirements. The loads program interface module 308 may also create components 124 and connections 126 necessary to describe a boiler or chiller suitable for satisfying heating or cooling requirements, respectively.

A CAD software interface module 310 may allow a user to read the output data of a computer aided drafting (CAD) software package in order to acquire data concerning the interior spaces in a building designed with such a package. The CAD software interface module may automatically create components 124 or connections 126 based on the data output by the CAD software. For example a building designed using a CAD software package may include descriptions of several rooms. The CAD software interface module 310 may read the description of the rooms and automatically create components 124 describing the rooms and insert them into a project 116. A CAD software interface module 310 may also create other components 124 and connections 126 needed to provide HVAC services to the spaces. For example the CAD software interface module 310 may create boilers, chillers and air handlers and connect them to the spaces, sparing the user from the work of creating them himself or herself.

A retrieval module 312 may read in design data 114 that has been written to an output device 24 for substantially permanent storage so that a user may further access or modify the design data 114.

Referring to FIG. 14, an output module 320 may include a storage module 322, a schedule generation module 324 and a schematic generation module 326. A storage module 322 may write design data 114 to an output device 24 for more substantially permanent storage. Typically a storage module will store design data 114 on a hard disk 46 or any other type of storage device. A schedule generation module 324 may generate various schedules describing a project 116. Schedules generated by a schedule generation module 324 may include parts lists, cost summaries, power consumption summaries, and the like. A schematic generation module 326 may generate schematic representations of a project 116. Schematics that may be generated may include hydronic schematics, air flow schematics, air handler schematics and the like. The schematic generation module 326 may output the schematics in a computer readable form to any output device 24.

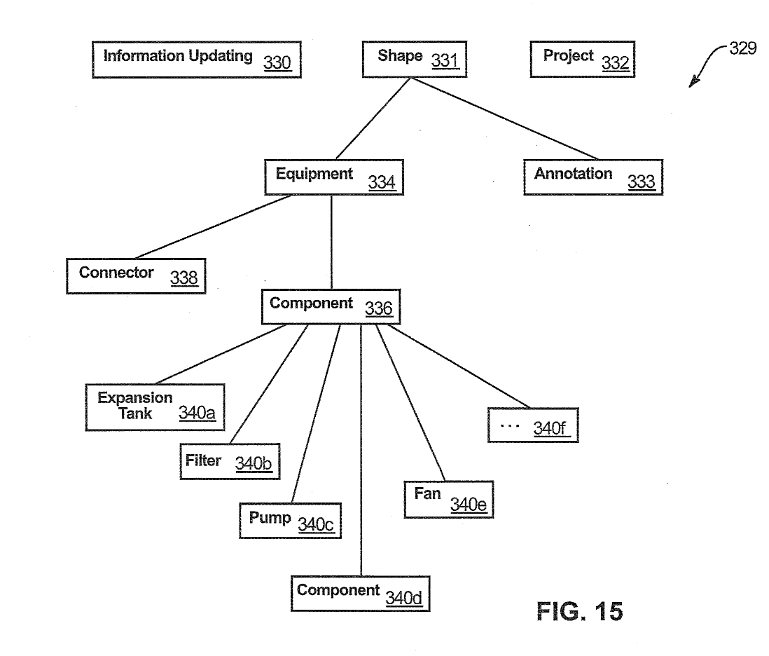

Referring to FIG. 15, an apparatus 10 may be implemented using an object oriented architecture 329. The functionality and operational data of the modules 82, 84, 86, 88, 90, 92, 94, 96, 98 and 102 may be provided by objects having methods and attributes. In one embodiment an object oriented architecture 329 of an apparatus 10 may include information updating objects 330 and project objects 332. The various elements of a design and functionality thereof may be embodied by a hierarchical scheme wherein objects 340a-f representing components inherit from a component object 336 which may inherit from an equipment object 334 which may inherit from a shape object 331. Likewise a connector object 338 may also inherit from an equipment object 334. In all of these cases inheritance implies that an object posses all of the methods and attributes possessed by the object from which it inherits.

An annotation object may contain text to associated with another object. An annotation object may include text and values to be displayed as well as data linking it to an equipment object 334, or project object 332. An annotation object 333 may contain data locating it on a screen as well as data determining its size. An annotation object 333 may include methods for accessing its attributes, modifying its screen position, updating the displayed text to reflect modifications to its attributes, and other necessary methods. In some embodiments an annotation object 333 may display text reflecting the attributes of the object 332,334 to which it is linked. In such an embodiment the updating method may automatically update the text displayed on the screen to reflect changes made to the attributes it reflects. For example, a boiler may have an annotation object 333 associated with it that displays the value for the boilers outlet temperature. In some embodiments an annotation object 333 may inherit from a shape object 331.

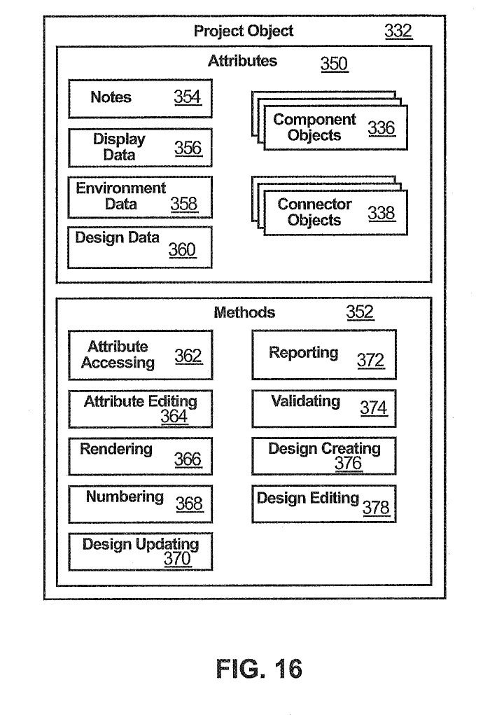

Referring to FIG. 16, a project object 332 may have attributes 350 comprising notes 354, display data 356, environment data 358, and design data 360. Notes 354 may comprise descriptive data that a user may want to add to a project such as comments justifying design decisions, or suggestions for implementation of a project. Notes 354 may also include annotation objects 333 that a project object 332 contains. Display data 356 may contain data determining how information is to be displayed by an output device 24. Display data 356 may include font settings, page formatting data, color settings, sizing settings, and the like. Environment data 358 may include information describing the physical location where the actual project being designed will be built. This information may include outside air conditions, geographies location, altitude, characteristics of the electricity supplied, and the like.

Design data 360 may include data describing the design a project contains. Design data 360 may include default data for the components 124 and connections 126 a project object 332 contains. The default data may be set by a user for a specific project object 332. For example a user may specify that every component or connection of a particular type have a default values for some or all of its attributes. Design data 360 may include preferences that govern the behavior of the apparatus 10 that a user wants to associate with a particular project object 332. This behavior may include the units in which variables are displayed, the appearance of a user interface, and the like.

A project object 332 may also contain components 124 and connections 126, which may be embodied as instances of component objects 336 and connector objects 338, respectively.

The methods of a project object 332 may include attribute accessing methods 362, attribute editing methods 364, rendering methods 366, numbering methods 368, design updating methods 370, reporting methods 372, validating methods 374, design creating methods 376 and design editing methods 378. Attribute accessing methods 362 and attribute editing methods 364 may allow a user to access and edit, respectively, the attributes 350 of a project object 332.

Attribute accessing and attribute editing methods 362,365 may permit a user or other objects to a access and edit, respectively, the attributes of a project object 332. Numbering methods 368 may assign and store identifying data to the components 126 and connections 124 of a project object 332 when they are added to a project object 332.

A rendering method 366 may function in conjunction with rendering methods 430, 450 of the component objects 336 and connector objects 338 it contains in order to display a graphical description of a project object 332 on an output device 24. Numbering methods 368 may assign and store identifying data to the components 124 and connections 126 of a project object 332 when they are added to a project object 332. Numbering methods 368 may also allow a user to modify the identifying data of the components 124 and connections 126.

Design updating methods 370 may maintain the consistency of the components 124, connections 126, and design data 360, such that when some data is modified, other data that is dependent on it is updated to reflect the change. Reporting method 372 or methods 372 may gather information from the attributes 350 of a project object 332 in order to generate reports, such as cost summaries, parts lists, and the like. Validating method 374 may analyze the attributes 350 of a project object 332 and determine if there are any unacceptable design configurations or parameters. A design creating method 375 may allow a user to insert components 124 and connections 126 into a project object 332. A design editing method 378 may permit a user or other objects to access and edit the attributes 350 of a project object 332.

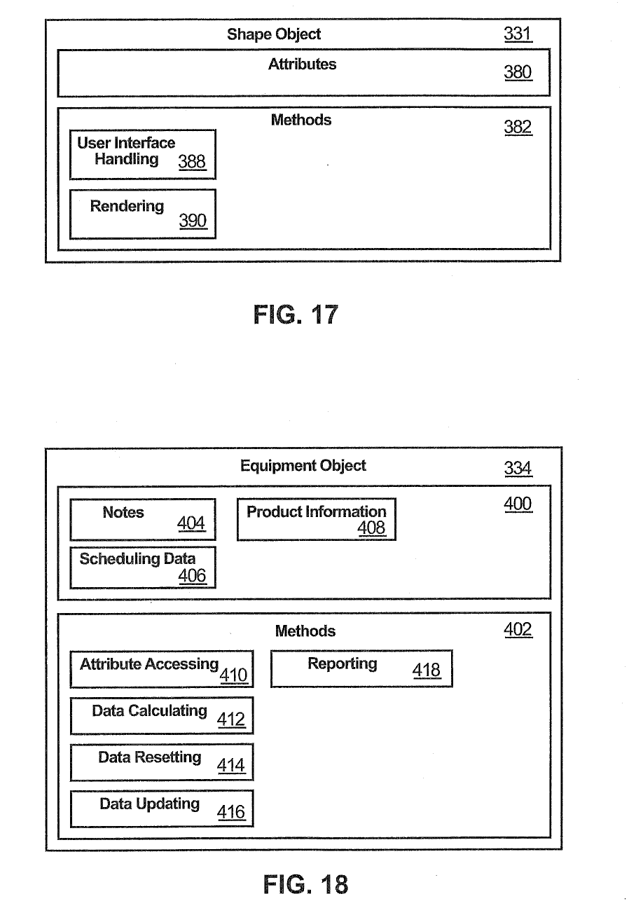

Referring to FIG. 17, the attributes of a shape object may have attributes 380 consisting of operational data necessary for the function of the methods 382. The methods 382 may comprise user interface handling method 388 and rendering methods 390. The methods 382 may be virtual functions which are defined by objects which inherit from the shape object 331. The user interface handling method 388 may receive and interpret mouse clicks, mouse movements, and the like. For example, a user interface method 388 may move the graphical representation of a shape object to a different location on a computer screen based on the movement of a mouse by a user.

Referring to FIG. 18, an equipment object 334 may inherit the methods and attributes of a shape object 331 as known in the object oriented programming arts. The attributes 334 of an equipment object 334 may, for example, comprise notes 404, scheduling data 406, and product information 408.

Notes 404 may likewise, for example, comprise any text a user may choose to associate with an instance of an equipment object 334. Notes 404 may also comprise data uniquely identifying an instance of an equipment object 334, notes may also be embodied as annotation objects 333 added by a user or associated automatically with an equipment object 334. Scheduling data 406 may comprise data needed for compiling reports or schedules about a project 116a,b. Scheduling data for an equipment object may include cost, energy consumption and the like. Product information 408 may include the name of the manufacturer or supplier of the equipment that the equipment object 334 represents. Product information 408 may also include the equipment's price or any other information associated with actual manufactured equipment.

The methods 402 of an equipment object 334 may include, for example, attribute accessing methods 410, data calculating methods 412, data updating 416 methods and reporting methods 418. Attribute accessing methods may allow a user or other objects to access the attributes of an instance of an equipment object 334. Data calculating methods 412 may calculate values for some of the attributes 400 of an instance of an equipment object 334 based on other attributes 400 of the instance. The data resetting method 414 may restore the values of the attributes 400 to their values previous to some modification or calculation. A reporting method 418 may provide information that is to be reported to the reporting method 372 of a project object 332. Reported data may include the energy usage data, cost and any other data that may need to be reported.

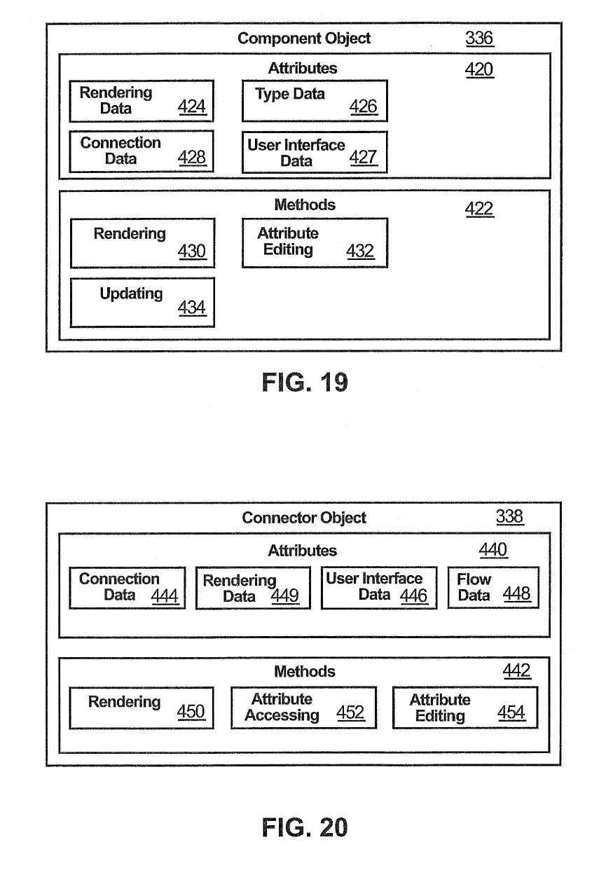

Referring to FIG. 19, a component object 336 may inherit from an equipment object 334. The attributes 420 of a component object 336 may include, for example, rendering data 424, connection data 428, type data 426 and user interface data 427. Rendering data 424 may include a graphical representation of an instance of a component object 336, its screen location, size and the like. Connection data 428 may include information indicating instances of connector objects 338 (FIG. 20) connected to the component object 336. Connection data 428 may include information indicating other component objects 336 connected to a component object 336.

Type data 426 may include data indicating which type of schematic an instance of a component object belongs. Type data 426 may also indicate what type of equipment a connection object is such as a pump, chiller, or the like. User interface data 427 may include the screen location, size and the like of a component object 336.

The methods 422 of a component object 336 may include, for example, rendering methods 430, updating methods 434, and attribute editing methods 432. Rendering methods 430 may include methods that render a graphical representations of a component object 336 to a computer screen or other output device 24. Rendering methods 430 may also provide some of the same functionality of a mapping module 154.

Attribute editing methods 432 may provide a means for a user or module 82, 84, 86, 88, 90, 92, 94, 96, 98, 102 to modify the attributes 420. Updating methods 434 may provide a means for a component object to update its attributes 420 to reflect changes made to relevant data stored in an apparatus 10.

Referring to FIG. 20, the attributes 440 of a connector object 338 may include, for example, connection data 444, rendering data 446, flow data 448 and user interface data 449. Connection data 444 may include information identifying the component objects 336 that a connector object 338 connects. Rendering data 446 may include data governing how a connector object 338 is displayed graphically. Rendering data 446 may include the screen location of a connector object 338, its shape, or the screen location of points it passes through. Flow data 448 may include the type or direction of fluid that is to pass through a connector object 338.

The methods 442 of a connector object 338 may include, for example, rendering methods 450, attribute accessing methods 452 and attribute editing methods 454. Rendering methods 450 may include methods that render a graphical representations of a connector object 338 to a computer screen or other output device 24. Rendering methods 450 may also provide some of the same functionality of a mapping module 154. Attribute accessing and editing methods 452, 454 may provide a means for a user or other objects to access and modify, respectively, the attributes 440.

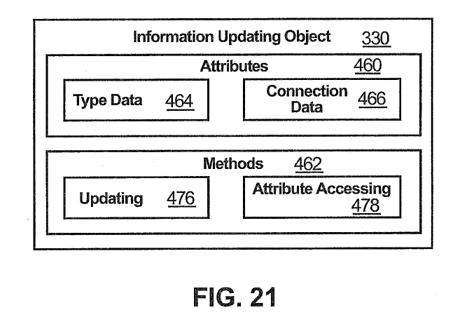

Referring to FIG. 21, the attributes of an information updating object 330 may include, for example, type data 464, connection data 466. A data updating method 416 of an equipment object 334 may create an information updating object in order to determine values for its attributes 400. A data updating method 416 of a project object 332 may analyze all the information updating object 330 created by the objects it contains and determine the information that each equipment object 334 needs.

The attributes 460 of an information updating object 330 may include, for example, data necessary to allow a project object 332 to update the attributes of the objects it contains. The attributes 460 may include, for example, type data 464 which may indicate what type of data an object needs. For example, a boiler object may need to know the inlet temperature of the fluid entering it, accordingly a boiler object may generate an information updating object with type data 464 indicating that it needs fluid temperature data.

Connection data 466 may indicate which other objects an object is connected to. A project object 332 may use this information to determine the needed information. For example, a boiler's inlet temperature is dependent on the other components 124 that connect to it. An updating method 476 may update the attributes of an object when the values thereof have been determined by the design updating method 370.

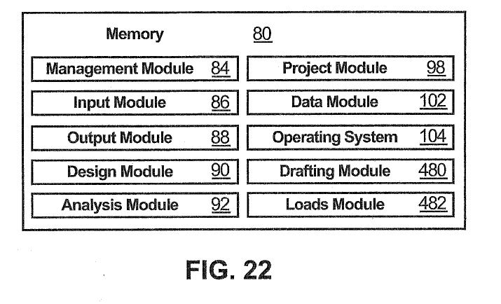

Referring to FIG. 22, in selected embodiments, executable data structures store in the memory 80 may include a drafting module 480. A drafting module 480 may assist a user in creating a virtual floor plan. For example, in certain embodiments, a drafting module 480 may cooperate with a user interface module 82 and data module 102 to present one or more palettes to a user. The palettes may contain selection buttons for creating images representing various structures such as walls, windows, doors, roofs, floors, and other elements suitable for creating a virtual floor plan. Once selected, the structures may be positioned by a user within a workspace (region 157). In one embodiment, a virtual floor plan may be created by tracing an imported drawing. In another embodiment, a virtual floor plan may be created from the dimensions provided by data, a hard copy plan, or inputs “from scratch.” Accordingly, a user may build a virtual floor plan by selected and positioning the various structures presented by the palettes.

In certain embodiments, a data module 102 may store information corresponding to a virtual floor plan and the various structures forming the virtual floor plan. The information may be used in calculating or predicting a thermal performance should the virtual floor plan be implemented in an actual, physical embodiment. For example, a data module 102 may store geographic or situational information identifying the location, elevation, orientation, shading, and the like for a virtual floor plan or the structures thereof. A data module 102 may also store physical information identifying dimensions, types of material, and the like for a virtual floor plan or the structures thereof.

In selected embodiments, memory 80 may store for execution a loads module 482. A loads module 482 may use the information stored within a data module 102 to calculate the requirements and actual performance values for air flow, heating, cooling, and the like for the spaces in a building. In selected embodiments, a loads module 482 may calculate a maximum heating requirement, a maximum cooling requirement, or both for each enclosed space contained with the virtual floor plan. Maximum heating and cooling requirements may respectively ensure adequate heating and cooling, even during more extreme weather.

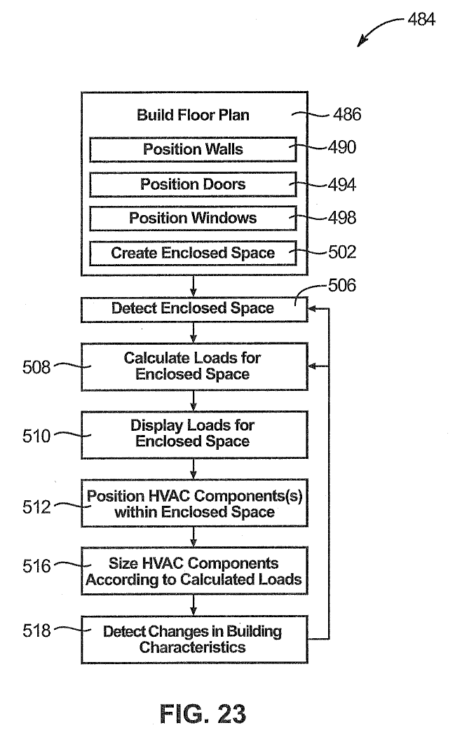

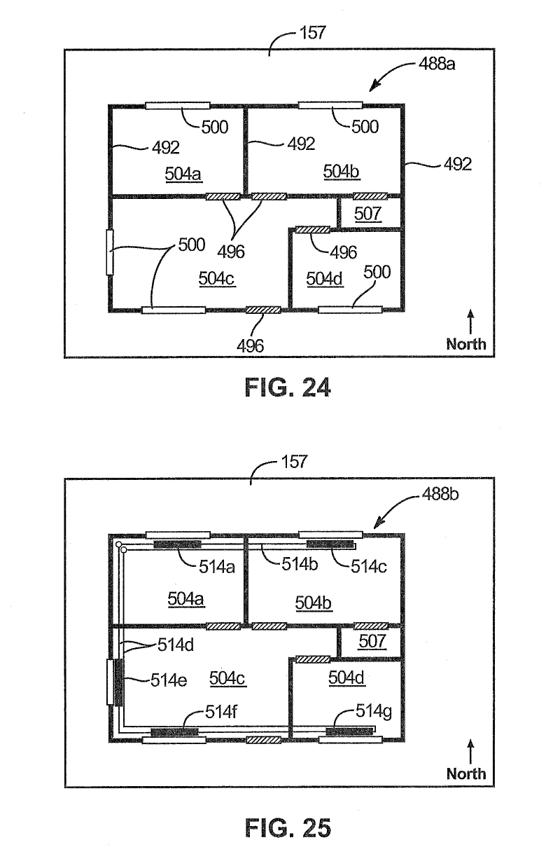

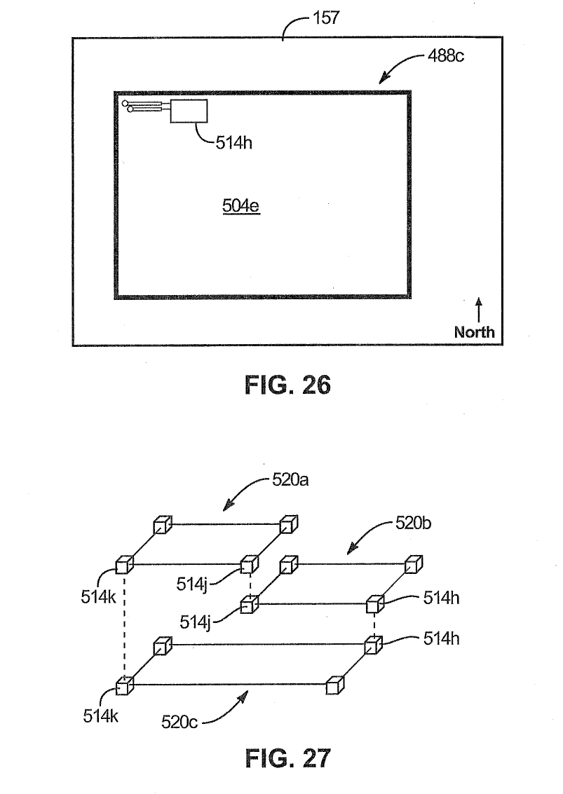

Referring to FIGS. 23-26, an apparatus 10 in accordance with the present invention may support a method 484 for designing an HVAC system. The method 484 may begin with building 486 a virtual floor plan 488. In selected embodiments, building 486 may include positioning and sizing the various structures (e.g., images representing them) forming the virtual floor plan 488. For example, building 486 may include positioning 490 and sizing walls 492, positioning 494 and sizing doors 496, positioning 498 and sizing windows 500, and the like.

In selected embodiments, a virtual floor plan 488 may provide a substantially proportionally accurate image corresponding to an actual building or an architectural drawing of a building. That is, the virtual floor plan 488 may be drawn substantially to scale. In such embodiments, the actual dimensions of the various structures 492, 496, 500 within a virtual floor plan 488 may be used by a loads module 482 in its calculations.

In certain embodiments, building 486 a virtual floor plan 488 may also include assigning to, or selecting for, each structure 492, 496, 500 information describing certain physical characteristics thereof. A data module 102 may store certain predefined informational packets. The informational packets may correspond to standard, typical, or common states of the virtual floor plan 488, structures 492,496,500 forming the virtual floor plan, or the like.

For example, one predefined informational packet may contain data necessary to calculate or predict the thermal performance or contribution of a wall 492 formed of vertical two-by-four studs covered on both sides by dry wall. In selected embodiments, a user may select from a menu of predefined informational packets to assign certain characteristic to a virtual floor plan 488 or to the structures 492, 496, 500 forming a virtual floor plan 488. Such a menu may permit selection of the composition of the various structures.

For example, for windows 500, a user may select the dimensions of the window, the number of window panes (e.g., single or double), the type of glass, the type of gas between the panes, and the like. For walls, a user may select the stud material and dimensions, wall covering material (e.g., dry wall, brick, stucco, wood paneling), insulations types, and the like Alternatively, a user may be permitted to input custom informational packets by inputting performance parameter information such as “R-values” and the like.

In certain embodiments, a user may be able to assign certain defaults to various structures 492, 496, 500. For example, when a user selects an interior wall 492 from a palette, the user may specify that the wall is to be a conventional, two-by-four and dry wall construction. Accordingly, unless the user specifies otherwise, the interior walls 492 may all be so designated.

In selected embodiments, building 484 a virtual floor plan 488 may include creating 502 enclosed spaces 504. An enclosed space 504 may be an area bounded by a continuous perimeter comprising one or more walls 492, doors 496, windows 500, or the like. In certain embodiments, a virtual floor plan 488a may comprise multiple enclosed spaces 504a, 504b, 504c, 504d. Alternatively, a virtual floor plan 488c may include only a single enclosed space 504e.

A method 484 for designing an HVAC system may include detecting 506 enclosed spaces 504 within a virtual floor plan 488. In selected embodiments, an apparatus 10 in accordance with the present invention may automatically detect each enclosed space 504 at its creation. Accordingly, if a user begins building 486 a virtual floor plan 488 by positioning 490, sizing, and connecting all of the exterior walls 492, then the apparatus 10 may detect the entire virtual floor plan 488 as a single enclosed space 504. However, as the user continues building 486 the virtual floor plan 488 by positioning 490, sizing, and connecting interior walls 492, the apparatus 10 may detect the new enclosed spaces 504 formed through subdivision.

In certain embodiments, an apparatus 10 in accordance with the present invention may detect 506 overlapping enclosed spaces 504. For example, the exterior walls 492 may define a first enclosed space 504, while interior walls 492 (e.g., acting in cooperation with one or more of the exterior walls 492) may form a second enclosed space 504 overlapping a portion of the first enclosed space 504. In such situations, an apparatus 10 may subdivide the first enclosed space 504, leaving the second enclosed space 504 and a third enclosed space 504 (comprising the remaining portion of the first enclosed space 504 not occupied by the second enclosed space 504). Accordingly, in certain embodiments, an enclosed space 504 may be defined as a continuous (e.g., whole, unbroken, unsubdivided) area bounded by a continuous perimeter comprising one or more walls 492, doors 496, windows 500, or the like.

An apparatus 10 in accordance with the present invention may determine that certain areas 507 within a virtual floor plan 488 may be too small to be considered enclosed spaces 504. For example, an apparatus 10 may include a square footage limit. Areas 507 having less square footage than the limit may be not be treated by the apparatus 10 as independent enclosed spaces 504. A closet 507 may be a good example of an area that may be below such a square footage limit. When an apparatus 10 encounters such an area 507, the apparatus 10 may treat the area 507 as part of the larger enclosed space 504b from which the area 507 depends. Accordingly, any air flow, heating, or cooling considerations or requirements for the area 507 may be added to those of the larger enclosed space 504b.

Once an enclosed space 504 has been detected 506, an apparatus 10 (e.g., a loads module 482) may calculate 508, and optionally display 510, the loads associated with that enclosed space 504. In so calculating 508, an apparatus 10 may take into account any factor desired. Typical factors or characteristics considered when calculating 508 may include code requirements, elevation, orientation with respect to the solar patterns, solar exposure, seasonal temperatures, dimensions, R-values, expected occupancy, characteristics of other enclosed spaces 504, and the like.

A method 484 for designing an HVAC system may include positioning 512 and connecting various HVAC components 514 (e.g., HVAC components 124 and connections 126) within a virtual floor plan 488. In selected embodiments, positioning 512 HVAC components 514 may include selecting components 415 from a palette. The palettes may contain representations (e.g., tools, icons, buttons) for various components 512 suitable to meet the HVAC requires of the enclosed spaces. Once selected, the components 512 may be positioned 512 and connected by a user within the virtual floor plan 488 (e.g., within the various enclosed spaces 504 within the virtual floor plan 488).

A method 484 for designing an HVAC system may further include sizing 516 HVAC components 514 according to calculated loads. In selected embodiments, an apparatus 10 in accordance with the present invention may automatically size (e.g., assign a capacity to) certain HVAC components 514 within a virtual floor plan 488. For example, an HVAC component 514a may be assigned to a particular enclosed space 504a. Accordingly, an apparatus 10 may assign a capacity to that component 514a. For example, that capacity may be sufficient to satisfy at least one of the maximum heating requirement, maximum cooling requirement, and the like of the enclosed space 504a.

In selected embodiments, an HVAC component 514 may be assigned to multiple enclosed spaces 504. For example, a boiler 514h may serve various enclosed spaces 504a, 504b, 504c, 504d. Such components 514 may be assigned a capacity sufficient to satisfy the requirements of the multiple enclosed spaces 504. Accordingly, the boiler 514h may be sized to satisfy the heating requirements of the various enclosed spaces 504a, 504b, 504c, 504d.

Alternatively, multiple HVAC components 514 may be assigned to such spaces, or even to a single enclosed space 504. For example, two hydronic heaters 514e, 514f may serve a single enclosed space 504c. Such components 514 may be assigned respective capacities that collectively satisfy the requirements of the single enclosed space 504. Accordingly, in the illustrated embodiment, the two hydronic heaters 514e, 514f may collectively meet the heating requirements of the enclosed space 504c in which they are located (e.g., each may supply half the requirement).

Selected HVAC components 514 may be considered conductors 514, responsible for conducting fluids (e.g., gases, liquids) to other component 514 such as radiators, vents, and the like. In selected embodiments, certain losses may be attributed to conductors 514. For example, in a hydronic system, the pipes 514b, 514d may conduct hot water or steam. Heat may be lost (e.g., conducted, convected, or radiated away) from the pipes 514b, 514d. The amount of heat lost may depend on the construction (e.g., whether insulated) and length of the pipe 514b, 514d. Because a hydronic system modeled in accordance with the present invention may be created to scale, an apparatus 10 may calculate the heat loss of conductors 514. Accordingly, such losses may be taken into account when sizing other HVAC components 514 (e.g., boilers 514h, etc.). Alternatively, when appropriate, such losses may be neglected as being insignificant.

In certain embodiments, an apparatus 10 in accordance with the present invention may store information corresponding to various HVAC components 514 available in the marketplace. Accordingly, once an apparatus has assigned a capacity to an HVAC component 514, the apparatus 10 may also provide to the user a listing of certain commercially available product candidates to support the assigned capacity. Using that information, a user may then specify a particular product for the virtual floor plan 488.

While the various steps for a method 484 in accordance with the present invention are being implemented, an apparatus 10 may continually search for and detect 418 changes in the virtual floor plan 488. When a change is detected 418, the apparatus 10 may take whatever steps 506, 508, 510, 516 are necessary to ensure that the effects of the change are properly propagated.

For example, a change may include the addition of a wall 492 subdividing an enclosed space 504 into multiple enclosed spaces 504. Accordingly, loads for each new enclosed space 504 may be calculated 508 and additional HVAC components 514 may be positioned 512 and sized 516. Other changes may require fewer steps to be retaken. For example, a change in the size of a window 492 may require a recalculation 508 of the loads. The new loads may then result in a resizing 516 of certain HVAC components 514.

Referring to FIG. 27, in selected embodiments, an apparatus 10 in accordance with the present invention may be used to design various systems 520 for a structure. The apparatus 10 may integrate the various systems 520, permitting decisions or changes in one such system 520 to fully propagate through all of other systems 520 affected thereby.

For example, an apparatus 10 in accordance with the present invention may support design of refrigeration systems 520, fuel systems 520 (e.g., oil, gas), plumbing systems 520, gas systems 520, steam systems 520, control systems 520, medical gas systems 520, fire suppression systems 520, data systems 520, electrical power systems 520, and the like. Components 514 of one system 520 may be also be components 514 of other systems 520. For example, a boiler 514h may reside in both a hydronic system 520b and a fuel system 520c. In the hydronic system 520b, the boiler 514h may heat water passing therethrough. In the fuel system 520c, the boiler 514h may be a consumer of fuel (e.g., oil).

Other connections between systems 520 may exist. For example, a water pump 514j may reside in both an electrical system 520a and a hydronic system 520b. A fuel pump 514k may reside in both an electrical system 520a and a fuel system 520c. Due to the connections and interrelations between the various systems 520, changes in one such system may necessitate changes in another system 520. An apparatus 10 in accordance with the present invention may detect changes in any such system 520 and propagate the effects of that change throughout all affected systems 520.

For example, adding a radiator 514c to a hydronic system 520b may require an increase in the capacity of the boiler 514h. Accordingly, the apparatus 10 may automatically assign a greater capacity to the boiler. The larger boiler 514h may require a larger water pump 514j to circulate the water and a larger fuel pump 514k to deliver more fuel. The apparatus 10 may, therefore, automatically assign a greater pumping capacity to the water pump 514j and the fuel pump 514k. The larger water pump 514j and fuel pump 514k may draw more current within the electrical system 520a. Accordingly, for example, the apparatus 10 may automatically upgrade the components of the electrical system 520a to accommodate the increased current requirements, and so forth.

From the foregoing, it will be appreciated that the present invention provides a powerful, integrated tool for design and analysis of HVAC and other related systems for handling and transport of fluids and power, with much of the integration and calculation transparent to a user.

The present invention may be embodied in other specific forms without departing from its principles or essential characteristics. The described embodiments are to be considered in all respects only as illustrative, and not restrictive. The scope of the invention is, therefore, indicated by the eventual claims that may issue, rather than by any specific description. All changes that come within the meaning and range of equivalency of such claims are to be embraced within their scope.

Wherefore we claim:

1. A method comprising:
selecting a computer system comprising at least one processor operably connected to at least one memory device, the at least one memory device storing a computer program, the at least one processor running the computer program;
operating the computer program to create a virtual floor plan providing a substantially proportionally accurate image reflecting a structure;
detecting automatically, by the computer program, a first enclosed space within the virtual floor plan;
calculating automatically, by the computer program after the detecting, a first load corresponding to the first enclosed space, the first load comprising a maximum heating requirement and a maximum cooling requirement for the first enclosed space;
providing, by the computer program, a palette of HVAC components;
instructing the computer program to assign at least one HVAC component from the palette to the first enclosed space; and
assigning automatically, by the computer program, a capacity to the at least one HVAC component, the capacity satisfying at least one of the maximum heating requirement and maximum cooling requirement.

2. The method of claim 1, wherein the first enclosed space is a continuous area bounded by a first continuous perimeter comprising a virtual wall.

3. The method of claim 2, wherein the first continuous perimeter further comprises a virtual door.

4. The method of claim 3, wherein the first continuous perimeter further comprises a virtual window.

5. The method of claim 4, further comprising communicating to the computer system a change in a physical characteristic of the virtual window.

6. The method of claim 5, wherein the physical characteristic is the dimension of the virtual window.

7. The method of claim 5, wherein the physical characteristic is the number of layers of glazing of the virtual window.

8. The method of claim 5, wherein the physical characteristic is the type of glazing used in the virtual window.

9. The method of claim 5, wherein the physical characteristic is a type of gas trapped between layers of glazing corresponding to the virtual window.

10. The method of claim 5, further comprising:
recalculating automatically, by the computer program after the communicating, the first load; and
reassigning automatically, by the computer program after the recalculating, the capacity of the at least one HVAC component.

11. The method of claim 2, wherein detecting further comprises detecting automatically, by the computer program, a second enclosed space within the virtual floor plan.

12. The method of claim 11, wherein calculating further comprises calculating automatically, by the computer program after the detecting, a second load corresponding to the second enclosed space, the second load comprising a maximum heating requirement and a maximum cooling requirement for the second enclosed space.

13. The method of claim 12, wherein the second enclosed space is an area bounded by a second continuous perimeter comprising the virtual wall.

14. The method of claim 13, further comprising communicating to the computer system a change in a physical characteristic of the virtual wall.

15. The method of claim 14, further comprising:
recalculating automatically, by the computer program after the communicating, the first load and the second load; and
reassigning automatically, by the computer program after the recalculating, the capacity of the at least one HVAC component.

16. The method of claim 1, wherein the at least one HVAC component comprises a first heater and a second heater.

17. The method of claim 16, wherein assigning further comprises assigning automatically, by the computer program, a first capacity to the first heater and a second capacity to the second heater, the first and second capacities together satisfying the maximum heating requirement.

18. The method of claim 17, wherein the first capacity is equal to the second capacity.

19. A method comprising:
selecting a computer system comprising at least one processor operably connected to at least one memory device, the at least one memory device storing a computer program, the at least one processor running the computer program;
operating the computer program to create a virtual floor plan providing a substantially proportionally accurate image corresponding to an architectural structure;
detecting automatically, by the computer program, a plurality of enclosed spaces within the virtual floor plan, each enclosed space of the plurality of enclosed spaces being a continuous area bounded by a first continuous perimeter comprising one or more virtual walls, virtual windows, or virtual doors;
calculating automatically, by the computer program after the detecting, for each enclosed space of the plurality of enclosed spaces a maximum heating requirement corresponding thereto;
providing, by the computer program, a display comprising a palette of HVAC components;
selecting by a user inputs to the computer program to assign at least one heat source from the palette to each enclosed space of the plurality of enclosed spaces; and
sizing automatically, by the computer program, each at least one heat source to satisfy the maximum heating requirement corresponding thereto.

20. A method comprising:
selecting a computer system comprising at least one processor operably connected to at least one memory device, the at least one memory device storing a computer program, the at least one processor running the computer program;
operating the computer program to create a virtual floor plan comprising structures selected from the group consisting of virtual walls, virtual doors, and virtual windows;
maintaining, by the computer program, data corresponding to each of the structures from which expected thermal performance of each of the structures may be calculated;
detecting automatically, by the computer program, an enclosed space within the virtual floor plan, the enclosed space being a continuous area bounded by a first continuous perimeter comprising one or more of the structures;
calculating automatically, by the computer program after the detecting, using the data, a maximum heating requirement and a maximum cooling requirement corresponding to the enclosed space;
providing, by the computer program, a palette representing selections of HVAC components;
using the computer program to assign at least one HVAC component, selected from the palette, to the enclosed space;
assigning automatically, by the computer program, a capacity to the at least one HVAC component, the capacity satisfying at least one of the maximum heating requirement and maximum cooling requirement;
changing the data;
recalculating automatically, by the computer program after the changing, using the data, the maximum heating requirement and maximum cooling requirement corresponding to the enclosed space; and
assigning automatically, by the computer program after the recalculating, a new capacity to the at least one HVAC component, the new capacity satisfying at least one of the maximum heating requirement and maximum cooling requirement as recalculated.
